(19) United States
(12) Patent Application Publication
(10) Pub. No.: US 2004/0122983 A1
(43) Pub. Date: Jun. 24, 2004

(54) Deadline scheduling with buffering

(76) Inventors: Robin C.B. Speed, Winchester (GB); Mingtzong Lee, Woodinville, WA (US); Jane W.S. Liu, Bellevue, WA (US)

Correspondence Address: LEE & HAYES PLLC, 421 W RIVERSIDE AVENUE SUITE 500, SPOKANE, WA, 99201

(21) Appl. No.: 10/322,818

(22) Filed: Dec. 18, 2002

(51) Int. Cl. G06F 3/00

(52) U.S. Cl. 710/1

(57) ABSTRACT

Systems and methods are described for using buffers with deadlines to schedule tasks for processing by a system. Since each buffer may be filled earlier than a time when the buffer must be ready for processing (e.g., rendering), a system scheduler is able to fill buffers when resource is available instead of having to wait until a task must be processed to access the resource. Thus, the load on the system is reduced. Since each buffer is guaranteed to be processed by its deadline, no artifacts occur in application processing due to an overload of system resources.

### TECHNICAL FIELD

The systems and methods described herein relate to multitasking computing systems. More particularly, the systems and methods described herein relate to multitasking computing systems that allocate computing resources among competing applications using deadlines.

### BACKGROUND

Computer systems that support multitasking allocate computer resources among competing applications that submit tasks to be performed by the computer. Some of these tasks must be completed in real time. For example, video frames from a multimedia application must be rendered at a correct time when playing video.

Deadline scheduling is a technique used to schedule competing tasks so that each task gets executed on time. One example of where deadline scheduling may be used is when a multimedia application task requires a certain amount of CPU (central processing unit) time to decode a compressed audio or video frame before the frame can be processed.

Another example is when an application task performs a disk I/O (input/output) to retrieve data that is to be processed by a certain time. Disk input/output (I/O) requests can impose severe demands on disk seeking, which is one of the most costly operations for a disk. Many disk I/O requests with approaching deadlines can cause a system to miss one or more of the deadlines. They also handicap the disk subsystem's ability to minimize seeking according to algorithms, such as the well known Elevator algorithm.

Deadline scheduling may be implemented by having application programs request ahead of time that either an amount of resource be made available (for example, a given amount of CPU time) or a task be completed (for example, a disk I/O) by a given time (i.e., the deadline). Thus, the application programs notify the operating system of their resource of timing requirements. The operating system then uses this information to schedule activities in the system so that as many requests as possible (usually all) are completed by their requested deadlines. If a deadline is missed, then there is a glitch in the processing of the application that may cause audio or video distortion or some other artifact.

A problem with simply scheduling tasks based on the next deadline is that it does not provide the CPU scheduler with much flexibility in distributing CPU time. If too many tasks are submitted for too many approaching deadlines, the system can miss one to several deadlines.

### SUMMARY

Systems and methods are described for scheduling tasks with deadlines using additional buffering to increase scheduling flexibility. Specifically, the described systems and methods provide for scheduling tasks using buffers with multiple sequential deadlines assigned, one to each buffer, that identify a time by which the buffer must be processed. Thus, for a single sequential application task, several deadlines may be simultaneously active at any given time, one deadline for each unprocessed buffer. The described systems and methods are an improvement over previous techniques because the operating system is provided with more flexibility as far as when each buffer is processed.

Individual buffers in a series of buffers can be processed when the CPU (or disk IO system) has time to process the buffers. More than one buffer is available to be processed at the system's convenience. For instance, the operating system may be able to distribute CPU time such that five buffers can be processed before the buffers' deadlines; wherein by submitting deadlines for tasks the CPU is limited on when it can process the tasks. Additionally, in some applications, the CPU can even process the buffers out of order if convenient, as long as each buffer is processed by its deadline.

### BRIEF DESCRIPTION OF THE DRAWINGS

A more complete understanding of exemplary methods and arrangements of the present invention may be had by reference to the following detailed description when taken in conjunction with the accompanying drawings wherein:

FIG. 1 is a block diagram of a computing system.

FIG. 2 is a flow diagram depicting a methodology for scheduling buffer deadlines.

FIG. 3 is a diagram depicting setting deadlines for a series of buffers.

FIG. 4 is a diagram of an exemplary system on which the present invention may be implemented.

### DETAILED DESCRIPTION

The following describes systems and methods for scheduling tasks using buffers with deadlines by which the buffers must be processed. The following description refers to an application that performs a relatively repetitive task, namely, a multimedia application that decodes video frames and/or reads multimedia content from a file. However, it is noted that the described techniques are not limited to strictly repetitive tasks, as will be discussed in more detail below.

Using buffers to submit and process tasks in known in the art. Typically, using buffers to schedule resources in a case in which a task is performed repeatedly is accomplished by scheduling a repeating deadline (for repeating buffers), each deadline specifying a fixed resource. However, this technique does not exploit the availability of extra buffers to reduce the load on the system because the system still has to deliver resources or complete tasks every fixed time interval.

A more sophisticated technique (assuming an application that uses “n” buffers) is to request “n” times the resource within “n” times the time. This technique helps exploit the possibility that the operating system may be able to complete tasks ahead of time. This technique does, however, have some drawbacks. For one, the technique actually requires 2*(n−1) buffers because “n” buffers are only guaranteed to be processed and ready for rendering when an “n-buffer” deadline expires. Meanwhile, “n−1” buffers processed during the previous “n buffer” deadlines are used to render during the current period up to the deadline for the last buffer. Another drawback is that this technique only provides limited flexibility for the operating system and can result in resources being delivered too early if insufficient buffers are deployed.

The systems and methods described herein relate to a technique that creates a separate deadline for each of multiple buffers. The deadlines can either be periodic or each buffer deadline may be renewed when the buffer becomes free. The technique allows the deadline scheduling mechanism in the operating system to be notified of the resources required to fill each individual buffer as soon as that buffer is free, thus allowing the system to process buffers early if possible, but not earlier than a buffer is ready to be processed.

The described technique is not strictly limited to repetitive tasks. If the work load is uneven or occurs at uneven intervals the individual elements can still be scheduled with overlapping deadlines (i.e., multiple deadlines active at any given time) individually. This provides a way to fill more than one buffer ahead of the buffer deadlines in the event that resources are available to process the buffers.

If the task is a repetitive task and the operating system allows a repeated deadline to be specified with a constant time between each deadline, the application can implement the technique by specifying one repetitive deadline for each buffer with a deadline “n” multiplied by the time between repetitions if “n” buffers are utilized.

Exemplary Environment

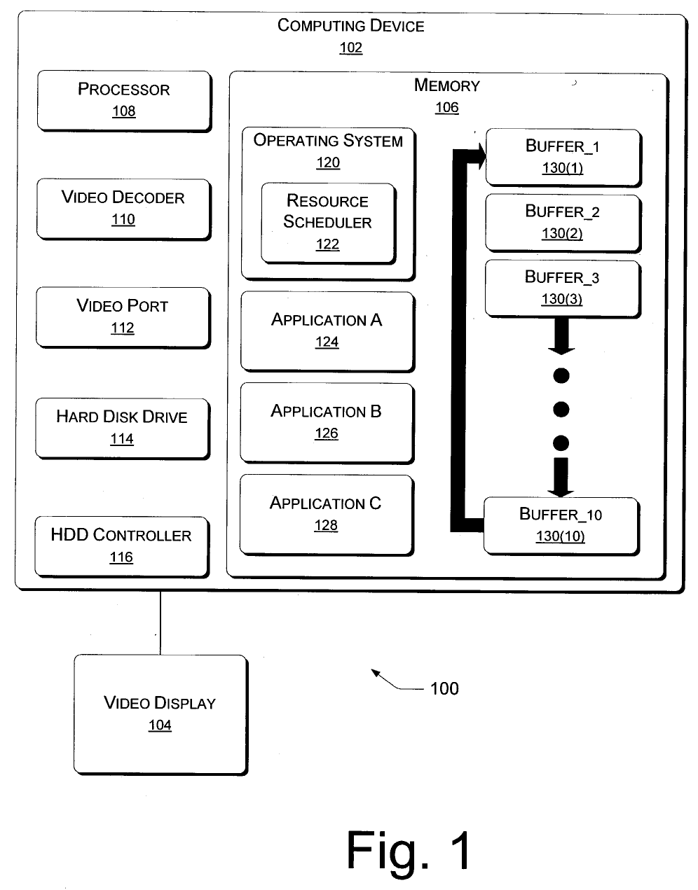

FIG. 1 is a block diagram of an exemplary environment 100 in which the presently described systems and methods may be implemented. The exemplary environment includes a computing device 102 connected to a video display 104. The computing device 102 includes memory 106, a processor 108, a video decoder 110, a video port 112 through which the computing device communicates with the video display 104, a hard disk drive 114 and a hard disk controller 116.

The memory 106 stores an operating system 120 that includes a resource scheduler 122, and several applications that execute on the processor 108, particularly, application A 124, application B 126 and application C 128. It is noted that a greater or smaller number of applications may run concurrently on the computing device 102, but only three applications 124-128 are shown in the present example.

The memory 106 is also shown including a series of buffers 130. Although any practical number of buffers may be used to implement the techniques described herein, the present example shows ten buffers 130(1)-130(10). The buffers 130 are created by application A 124 (in this example) for use in processing application A 124. In the present example, application A 124 is a multimedia video application that requires decoding video frames and rendering them on the video display. In other words, the video application will need to fill buffers with data from the hard disk drive 114 and render buffers on the video display 104. Specifically, but without limitation, the example described below focuses only on the rendering process. Those skilled in the art will recognize that the described process may be applied to other implementations. Furthermore, the discussion below refers to processing buffers, which is meant to include filling buffers and rendering buffers depending on the resource utilized with the buffers.

It is noted that, although only one series of buffers 130 is shown, one or more other series of buffers may be utilized for other tasks. For example, application A 124 requires disk I/O time to repeatedly read video frame data from the hard disk drive 114—a task for which utilizing a series of buffers would be advantageous. In that case, a second series of buffers could be used to provide the resource scheduler 122 with greater flexibility to allocate the disk I/O tasks. However, to clarify the description, only the one series of buffers 130 will be described in conjunction with the video tasks of application A 124.

The series of buffers 130 is logically circular, in that buffer_1 130(1) is processed again after buffer_10 130(10) is processed. As will be discussed in greater detail below, the buffers 130(1)-130(10) are used repeatedly until the task(s) associated with the buffers is/are complete.

It is noted that a typical computer system includes more and/or different elements than those shown in the computing device 102 of FIG. 1. However, other elements that are not shown but that may be present in the computing device 102 are not necessarily relevant to the present discussion. If any such other elements are included in the discussion below, it is assumed that those elements, their presence in the device and their functions are well known in the art. The following discussion will continue to reference the elements and reference numerals shown in FIG. 1.

### Exemplary Methodological Implementation

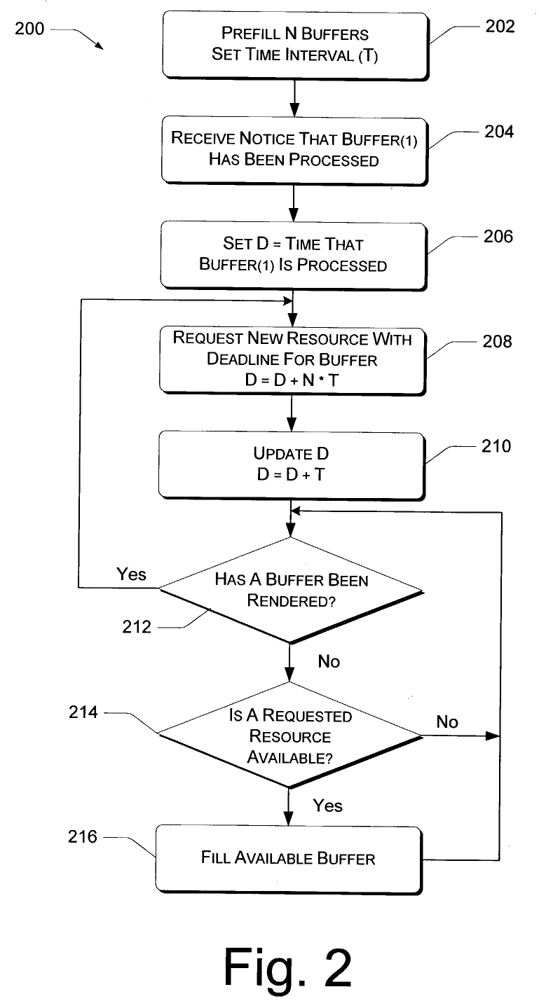

FIG. 2 is a flow diagram 200 depicting a methodological implementation for scheduling tasks using buffers with processing deadlines. The described methodological implementation refers to an example of an application program (application A 124) that decodes and displays video frames utilizing the series of buffers 130. For clarity, only the one series of buffers is described, although one or more other series of buffers could be implemented to handle other repetitive tasks, such as reading encoded video frames from the hard disk drive 114. The resource requested in the following example is processor time necessary to fill a buffer.

Initially at block 202, application A 124 pre-fills each buffer in the series of buffers 130 with video data ready to be displayed at an appropriate time. It is noted that for some tasks, the buffers do not need to be pre-filled. For example, if the task requires disk I/O time to read data from a disk, then the buffers are not pre-filled. The process discussed below would simply begin when a first buffer is filled with the disk I/O. An alternative implementation of the invention might instead start with no pre-filled buffers and schedule the first buffer to be rendered at time D+N*T rather than time D (see below).

Although any practical number of buffers may be used, the present example includes ten (10) buffers. In the following discussion, “N” represents the number of buffers (ten in this example) and “T” represents a time that elapses between buffers. In other words, a buffer is rendered every “T” units of time. (Note that the buffers may be processed at any time interval as allocated by the processor 108.)

When buffer 1_130(1) has been rendered, the application A 124 receives notice that buffer_1 130(1) has been rendered at block 204. When the notification is received, application A 124 sets “D” to the time when buffer_1 130(1) was rendered (block 206). It should be noted that an alternative implementation would be to set D to some time after buffer _1 130(1) was rendered, such as the time the notification was received. Application A 124 now knows that buffer_1 130(1) is free and will proceed to schedule buffer_1 130(1) to be filled and rendered (displayed) for its next scheduled render time of D+N*T.

Application A 124 submits a request to the resource scheduler 122 of the operating system 120 for buffer_1 130(1) to be processed prior to a deadline for buffer_1 130(1) (block 208). The deadline for buffer_1 130(1) (D, B(1)) is set to D+N*T, which is essentially the time length of the series of buffers 130 from the present time, D. For example, if “T” is equal to three (3) milliseconds, then N*T is thirty (30) milliseconds in this example with ten (10) buffers.

At block 210, application 124 updates “D” by adding “T” (buffer length) to the present “D”. If a buffer becomes free, i.e. a buffer is rendered (“Yes” branch block 212), then blocks 208 and 210 are repeated to request a new resource. The newly requested resource is associated with the buffer, and a deadline is calculated for the buffer to be filled for display. “D” is updated each time a deadline for a buffer is set.

If a buffer is not rendered (“No” branch, block 212) but a notification indicates that a requested resource (processor time) is available (“Yes” branch, block 214), then a buffer is filled at block 216. If no such notification is received (“No” branch, block 214) then the application simply waits for the next event to occur, whether it is a buffer becoming free (by being rendered) or a requested resource becoming available (to fill one or more empty buffers).

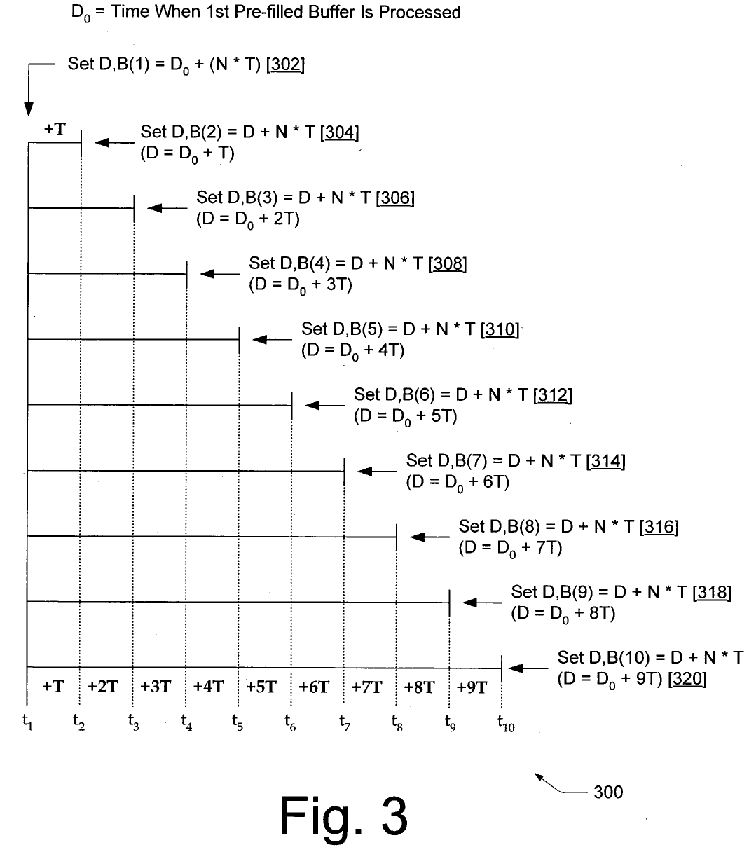

FIG. 3 is a diagram depicting setting deadlines for the series of buffers 130. D₀ indicates the time when buffer_1 130(1) of the pre-filled buffers is processed as described in block 206, above. At 302, a deadline for buffer_1 130(1)-D, B(1)- is set to D₀+N*T. Thereafter (block 210 of FIG. 2), application A 124 updates D by incrementing it by a buffer interval, T.

At 304, a deadline for buffer_2 130(2)-D, B(2)-is set to D+N*T. Since D was updated, buffer_2 130(2) has a deadline that is one buffer interval, T, from the buffer deadline for buffer_1 130(1). At 306, a deadline for buffer_3 130(3) -D, B(3)-is set to D+N*T. Since D was updated since the last deadline was set, buffer-3 130(3) has a deadline that is two buffer intervals (2T) later than the deadline for buffer_1 130(1).

As the diagram shows, each successive buffer is assigned a deadline that is an additional buffer interval (T) later than the deadline for the previous buffer. Finally, at 320, a deadline for buffer_10 139(10)-D, B(10)-is set that is nine (9) buffer intervals later (9T) than the deadline for buffer_1 130(1). After buffer_1 130(1) is processed, a resource is requested with a new deadline for buffer_1 130(1). The process continues to rotate through each buffer in the series of buffers 130 until no further processing is required. In this example in the normal steady state 10 deadlines are normally active except for short periods between a buffer becoming free and a new deadline for it being scheduled. As an example of the flexibility of this technique it should be noted that if another application requires 5 CPU time units cyclically starting at the beginning of each 10 time units the operating system can easily schedule the CPU resources to fill each buffer in the remaining 5 time units and buffers will still be available to be rendered at their respective deadlines.

### Exemplary Computer Environment

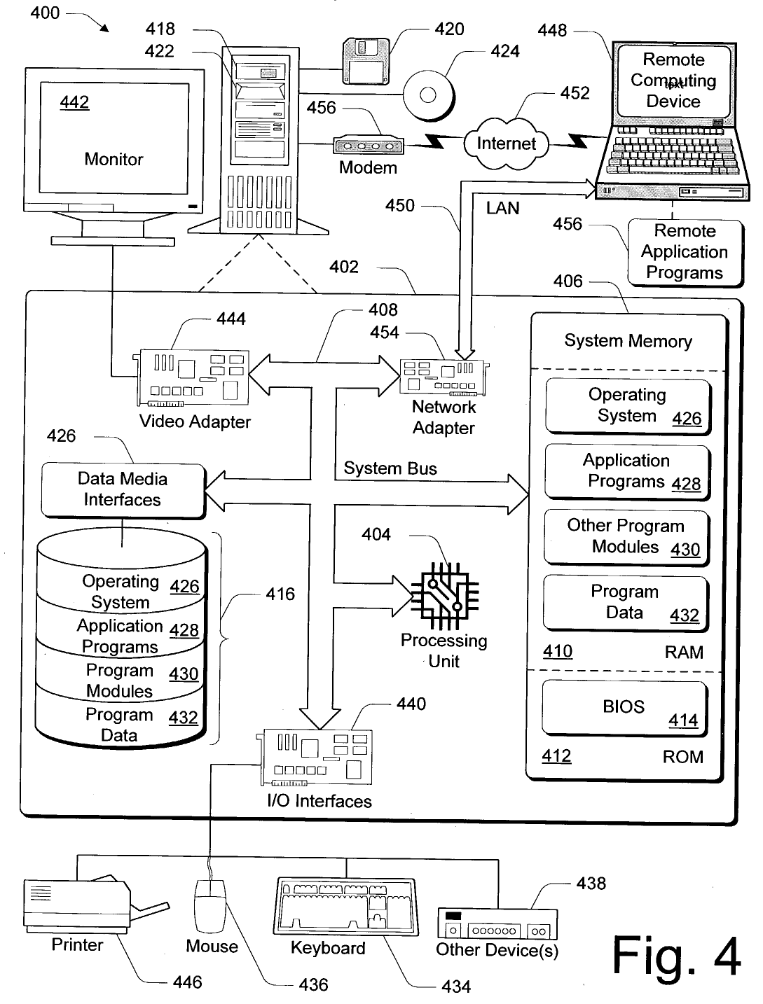

The various components and functionality described herein are implemented with a computing system. FIG. 4 shows components of typical example of such a computing system, i.e. a computer, referred by to reference numeral 400. The components shown in FIG. 4 are only examples, and are not intended to suggest any limitation as to the scope of the functionality of the invention; the invention is not necessarily dependent on the features shown in FIG. 4.

Generally, various different general purpose or special purpose computing system configurations can be used. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The functionality of the computers is embodied in many cases by computer-executable instructions, such as program modules, that are executed by the computers. Generally, program modules include routines, programs, objects, components, data structures, etc. that perform particular tasks or implement particular abstract data types. Tasks might also be performed by remote processing devices that are linked through a communications network. In a distributed computing environment, program modules may be located in both local and remote computer storage media.

The instructions and/or program modules are stored at different times in the various computer-readable media that are either part of the computer or that can be read by the computer. Programs are typically distributed, for example, on floppy disks, CD-ROMs, DVD, or some form of communication media such as a modulated signal. From there, they are installed or loaded into the secondary memory of a computer. At execution, they are loaded at least partially into the computer's primary electronic memory. The invention described herein includes these and other various types of computer-readable media when such media contain instructions programs, and/or modules for implementing the steps described below in conjunction with a microprocessor or other data processors. The invention also includes the computer itself when programmed according to the methods and techniques described below.

For purposes of illustration, programs and other executable program components such as the operating system are illustrated herein as discrete blocks, although it is recognized that such programs and components reside at various times in different storage components of the computer, and are executed by the data processor(s) of the computer.

With reference to FIG. 4, the components of computer 400 may include, but are not limited to, a processing unit 402, a system memory 404, and a system bus 406 that couples various system components including the system memory to the processing unit 402. The system bus 406 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISAA) bus, Video Electronics Standards Association (VESA) local bus, and Peripheral Component Interconnect (PCI) bus also known as the Mezzanine bus.

Computer 400 typically includes a variety of computer-readable media. Computer-readable media can be any available media that can be accessed by computer 400 and includes both volatile and nonvolatile media, removable and non-removable media. By way of example, and not limitation, computer-readable media may comprise computer storage media and communication media. “Computer storage media” includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 400. Communication media typically embodies computer-readable instructions, data structures, program modules or other data in a modulated data signal such as a carrier wave or other transport mechanism and includes any information delivery media. The term “modulated data signal” means a signal that has one or more if its characteristics set or changed in such a manner as to encode information in the signal. By way of example, and not limitation, communication media includes wired media such as a wired network or direct-wired connection and wireless media such as acoustic, RF, infrared and other wireless media. Combinations of any of the above should also be included within the scope of computer readable media.

The system memory 404 includes computer storage media in the form of volatile and/or nonvolatile memory such as read only memory (ROM) 408 and random access memory (RAM) 410. A basic input/output system 412 (BIOS), containing the basic routines that help to transfer information between elements within computer 400, such as during start-up, is typically stored in ROM 408. RAM 410 typically contains data and/or program modules that are immediately accessible to and/or presently being operated on by processing unit 402. By way of example, and not limitation, FIG. 4 illustrates operating system 414, application programs 416, other program modules 418, and program data 420.

The computer 400 may also include other removable/non-removable, volatile/nonvolatile computer storage media. By way of example only, FIG. 4 illustrates a hard disk drive 422 that reads from or writes to non-removable, nonvolatile magnetic media, a magnetic disk drive 424 that reads from or writes to a removable, nonvolatile magnetic disk 426, and an optical disk drive 428 that reads from or writes to a removable, nonvolatile optical disk 430 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 422 is typically connected to the system bus 406 through a non-removable memory interface such as data media interface 432, and magnetic disk drive 424 and optical disk drive 428 are typically connected to the system bus 406 by a removable memory interface such as interface 434.

The drives and their associated computer storage media discussed above and illustrated in FIG. 4 provide storage of computer-readable instructions, data structures, program modules, and other data for computer 400. In FIG. 4, for example, hard disk drive 422 is illustrated as storing operating system 415, application programs 417, other program modules 419, and program data 421. Note that these components can either be the same as or different from operating system 414, application programs 416, other program modules 418, and program data 420. Operating system 415, application programs 417, other program modules 419, and program data 421 are given different numbers here to illustrate that, at a minimum, they are different copies. A user may enter commands and information into the computer 400 through input devices such as a keyboard 436 and pointing device 438, commonly referred to as a mouse, trackball, or touch pad. Other input devices (not shown) may include a microphone, joystick, game pad, satellite dish, scanner, or the like. These and other input devices are often connected to the processing unit 402 through an input/output (I/O) interface 440 that is coupled to the system bus, but may be connected by other interface and bus structures, such as a parallel port, game port, or a universal serial bus (USB). A monitor 442 or other type of display device is also connected to the system bus 406 via an interface, such as a video adapter 444. In addition to the monitor 442, computers may also include other peripheral output devices 446 (e.g., speakers) and one or more printers 448, which may be connected through the I/O interface 440.

The computer may operate in a networked environment using logical connections to one or more remote computers, such as a remote computing device 450. The remote computing device 450 may be a personal computer, a server, a router, a network PC, a peer device or other common network node, and typically includes many or all of the elements described above relative to computer 400. The logical connections depicted in FIG. 4 include a local area network (LAN) 452 and a wide area network (WAN) 454. Although the WAN 454 shown in FIG. 4 is the Internet, the WAN 454 may also include other networks. Such networking environments are commonplace in offices, enterprise-wide computer networks, intranets, and the like.

When used in a LAN networking environment, the computer 400 is connected to the LAN 452 through a network interface or adapter 456. When used in a WAN networking environment, the computer 400 typically includes a modem 458 or other means for establishing communications over the Internet 454. The modem 458, which may be internal or external, may be connected to the system bus 406 via the I/O interface 440, or other appropriate mechanism. In a networked environment, program modules depicted relative to the computer 400, or portions thereof, may be stored in the remote computing device 450. By way of example, and not limitation, FIG. 4 illustrates remote application programs 460 as residing on remote computing device 450. It will be appreciated that the network connections shown are exemplary and other means of establishing a communications link between the computers may be used.

### CONCLUSION

The systems and methods as described thus provide a way to schedule system resources using multiple buffers using multiple deadlines. The described technique provide flexibility to a system scheduler to schedule resources for tasks, because the scheduler can fill buffers before the buffer is to be processed if the resources to fill the buffer become available. The instantaneous load on a system is reduced and—as a result—the occurrence of application artifacts is reduced.

1. A method, comprising:
requesting a computer system resource to process a buffer in a series of buffers;
calculating a buffer deadline for the buffer by multiplying a number of buffers in the series of buffers by a time utilized by each buffer and adding that product to a time at which the buffer became available for processing; and
wherein the computer system resource is requested to process the buffer before the buffer deadline.

2. The method as recited in claim 1, wherein the buffer is a first buffer and the buffer deadline is a first buffer deadline, further comprising:
calculating a second buffer deadline for the second buffer by multiplying the number of buffers in the series of buffers by a time utilized by each buffer and adding that product to the time at which the second buffer became available for processing; and
wherein the computer system resource is requested to process the second buffer before the second buffer deadline.

3. The method as recited in claim 1, wherein the buffer processing further comprises:
receiving notice that the computer system resource requested for the buffer is available; and
filling the buffer using the computer system resource.

4. The method as recited in claim 1, further comprising pre-filling each buffer in the series of buffers with the requested computer system resource before a buffer is processed.

5. The method as recited in claim 1, wherein the computing system resource is central processing unit (CPU) time.

6. The method as recited in claim 1, wherein the computing system resource is disk input/output (I/O) bandwidth.

7. The method as recited in claim 1, wherein multiple buffer deadlines are active simultaneously for a single task.

8. The method as recited in claim 7, wherein the multiple buffer deadlines are sequential such that each buffer deadline falls after another of the buffer deadlines.

9. The method as recited in claim 1, wherein more than one buffer having a deadline may be filled at any time the requested computer system resource is available.

10. A computer system, comprising:
a processor;
an operating system including a resource scheduler;
one or more computer system resources;
memory;
a series of buffers configured in the memory;
wherein:
the resource scheduler is configured to receive a computer system resource request from one or more applications and, in response to the request, schedule a computer system resource to process at least one buffer in the series of buffers by a buffer deadline associated with the buffer; and
more than one buffer may be processed at any time the computer system resource is available.

11. The computer system as recited in claim 10, wherein the computer system resource request further comprises a request for processor time.

12. The computer system as recited in claim 10, wherein the computer system resource request further comprises a request for hard disk I/O time.

13. The computer system as recited in claim 10, wherein the buffer deadline is calculated by adding a product of the number of buffers in the series of buffers by a length of time utilized by each buffer to a current time.

14. The computer system as recited in claim 10, wherein:
the operating system is further configured to provide notice when the buffer has been processed; and
the buffer is resubmitted with a request for a resource by a new buffer deadline.

15. The computer system as recited in claim 14, wherein the buffer deadline is calculated by adding the time when the buffer was processed to the product of the number of buffers in the series of buffers by a length of time utilized by each buffer.

16. The computer system as recited in claim 14, wherein the buffer deadline is calculated by adding a product of the number of buffers in the series of buffers by a length of time utilized by each buffer to a previous buffer deadline associated with the buffer.

17. The computer system as recited in claim 10, wherein multiple buffer deadlines are active at the same time.

18. The computer system as recited in claim 10, wherein multiple buffers have sequential deadlines active simultaneously, so that each buffer deadline temporally follows another buffer deadline,

19. An application stored on one or more computer-readable media having processor-executable instructions that, when executed, perform the following steps:
submitting a request to a computer system operating system requesting one or more computer system resources;
submitting data to the computer system for processing, the data being submitted in appropriate amounts to fill at least one buffer in a series of buffers associated with the application;
assigning a deadline for each buffer utilized;
receiving notice when a buffer is processed;
requesting a computer system resource for the processed buffer;
assigning a deadline for the processed buffer; and
wherein multiple buffers in the series of buffers may be processed at any time that the computer system resource is available.

20. The application as recited in claim 19, wherein each buffer deadline is calculated as being a time when a buffer was processed plus the product of a number of buffers in the series of buffers and the time utilized by each buffer.

21. The application as recited in claim 19, wherein the computer system resource further comprises processor time for execution of application instructions.

22. The application as recited in claim 19, wherein the computer system resource further comprises disk I/O bandwidth.

23. The application as recited in claim 19, wherein the buffer deadlines associated with the series of buffers are scheduled sequentially and more than one buffer deadline is active simultaneously.

24. The application as recited in claim 19, wherein the buffer deadlines associated with the series of buffers are scheduled sequentially, but may be processed out of temporal order.

25. One or more computer-readable media containing computer-executable instructions that, when executed on a computer, perform the following steps:
configuring a series of buffers associated with an application;
receiving sufficient data from the application to pre-fill each buffer in the series of buffers;
associating a deadline for each buffer in the series of buffers, the deadlines identifying a time by which the associated buffer must be processed using a system resource;
processing a first buffer in the series of buffers;
receiving additional data from the application;
filling the first buffer with the additional data; and
associating a deadline with the first buffer.

26. The one or more computer-readable media as recited in claim 25, wherein a deadline for a buffer further comprises D+N*T, D being a time at which the first buffer was processed, T being a length utilized by each buffer and N being a number of buffers in the series of buffers.

27. The one or more computer-readable media as recited in claim 25, wherein a deadline for a buffer further comprises D+N*T, D being a time at which the first buffer was processed, T being a length utilized by each buffer and N being a number that begins at zero and increases by one for each deadline requested while processing the series of buffers.

28. The one or more computer-readable media as recited in claim 25, wherein the buffer deadlines associated with the buffers in the series of buffers are temporally sequential so that each buffer is processed after a previous buffer.

29. The one or more computer-readable media as recited in claim 25, wherein more than one buffer may be processed any time the computing system resource is available.

30. The one or more computer-readable media as recited in claim 25, wherein at least two buffer deadlines are active simultaneously.

31. The one or more computer-readable media as recited in claim 25,
processing a second buffer in the series of buffers;
receiving additional data from the application;
filling the second buffer with the additional data o be processed; and
associating a deadline with the second buffer.

32. The one or more computer-readable media as recited in claim 25, wherein the system resource is processor time required to process the data in each buffer of the series of buffers.

33. One or more computer-readable media containing computer-executable instructions that, when executed by a computer, perform the following steps:
receiving a resource request from an application requesting disk I/O bandwidth;
configuring a series of buffers associated with the application;
filling a first buffer in the series of buffers;
associating a deadline for the first buffer, the deadline identifying a time by which the first buffer must be filled with data utilizing disk I/O;
processing the data in the first buffer;
identifying a time when the first buffer was processed; and
associating a new deadline with the first buffer that identifies a time by which the first buffer should be re-filled.

34. The one or more computer-readable media as recited in claim 33, further comprising:
filling a second buffer in the series of buffers;
associating a deadline for the second buffer, the deadline identifying a time by which the second buffer must be filled with data utilizing disk I/O;
processing the data in the second buffer;
identifying a time when the second buffer was processed; and
associating a new deadline with the second buffer that identifies a time by which the second buffer should be re-filled.

35. The one or more computer-readable media as recited in claim 33, wherein a deadline is derived by adding the time at which the first buffer was processed to the product of a number of buffers in the series of buffers and the length of time utilized by each buffer.

36. The one or more computer-readable media as recited in claim 33, wherein the first buffer processing further comprises processing the data contained in the first buffer so that the data is no longer required to be stored in the first buffer.

37. The one or more computer-readable media as recited in claim 33, wherein:
each buffer in the series of buffers is associated with a buffer deadline, and more than one buffer deadline is active simultaneously.
